(19) United States
(12) Patent Application Publication
(10) Pub. No.: US 2005/0128220 A1
(43) Pub. Date: Jun. 16, 2005

(54) Methods and apparatuses for adjusting a frame rate when displaying continuous time-based content

(76) Inventors: Christopher F. Marrin, Los Altos, CA (US); James R. Kent, Gahanna, OH (US); Peter Broadwell, Palo Alto, CA (US); Robert K. Myers, Santa Cruz, CA (US)

Correspondence Address: Richard H. Butler, 5655 Silver Creek Valley Road, #106, San Jose, CA, 95138, US

(21) Appl. No.: 10/990,743

(22) Filed: Nov. 16, 2004

Related U.S. Application Data
(63) Continuation-in-part of application No. 09/632,350, filed on Aug. 3, 2000, now Pat. No. 6,856,322.
(60) Provisional application No. 60/147,092, filed on Aug. 3, 1999.

(51) Int. Cl. G06T 13/00

(52) U.S. Cl. 345/619

(57) ABSTRACT

In one embodiment, the methods and apparatuses detect hardware associated with a device configured for displaying authored content; set an initial frame rate for the authored content based on the hardware; and play the content at the initial frame rate, wherein the authored content is scripted in a declarative markup language.

### CROSS REFERENCE RELATED APPLICATIONS

This application is a continuation-in-part of application Ser. No. 10/632,350 filed on Aug. 3, 2000, which claims benefit of U.S. Provisional Application No. 60/147,092 filed on Aug. 3, 1999. The disclosure for U.S. patent application Ser. No. 09/632,350 is hereby incorporated by reference.

### FIELD OF INVENTION

This invention relates generally to a frame rate for displaying continuous time-based content, and, more particularly, to adjusting the frame rate.

### BACKGROUND

In computer graphics, traditional real-time 3D scene rendering is based on the evaluation of a description of the scene's 3D geometry, resulting in the production of an image presentation on a computer display. Virtual Reality Modeling Language (VRML hereafter) is a conventional modeling language that defines most of the commonly used semantics found in conventional 3D applications such as hierarchical transformations, light sources, view points, geometry, animation, fog, material properties, and texture mapping. Texture mapping processes are commonly used to apply externally supplied image data to a given geometry within the scene. For example VRML allows one to apply externally supplied image data, externally supplied video data or externally supplied pixel data to a surface. However, VRML does not allow the use of rendered scene as an image to be texture mapped declaratively into another scene. In a declarative markup language, the semantics required to attain the desired outcome are implicit, and therefore a description of the outcome is sufficient to get the desired outcome.

Thus, it is not necessary to provide a procedure (i.e., write a script) to get the desired outcome. As a result, it is desirable to be able to compose a scene using declarations. One example of a declarative language is the Hypertext Markup Language (HTML).

Further, it is desirable to declaratively combine any two surfaces on which image data was applied to produce a third surface. It is also desirable to declaratively re-render the image data applied to a surface to reflect the current state of the image.

Traditionally, 3D scenes are rendered monolithically, producing a final frame rate to the viewer that is governed by the worst-case performance determined by scene complexity or texture swapping. However, if different rendering rates were used for different elements on the same screen, the quality would improve and viewing experience would be more television-like and not a web-page-like viewing experience.

### SUMMARY

In one embodiment, the methods and apparatuses detect hardware associated with a device configured for displaying authored content; set an initial frame rate for the authored content based on the hardware; and play the content at the initial frame rate, wherein the authored content is scripted in a declarative markup language.

### BRIEF DESCRIPTION OF THE DRAWINGS

FIG. 1A shows the basic architecture of Blendo.

FIG. 1B is a flow diagram illustrating flow of content through Blendo engine.

FIG. 2A illustrates how two surfaces in a scene are rendered at different rendering rates.

FIG. 2B is a flow chart illustrating acts involved in rendering the two surfaces shown in FIG. 2A at different rendering rates.

FIG. 3A illustrates a nested scene.

FIG. 3B is a flow chart showing acts performed to render the nested scene of FIG. 3A.

FIG. 4 illustrates a block diagram describing a player for displaying Blendo content.

FIG. 5 illustrates a flow diagram illustrating displaying Blendo content.

FIG. 6 illustrates a timing diagram illustrating varying frame rates for displaying Blendo content.

### DETAILED DESCRIPTION

The following detailed description of the methods and apparatuses for adjusting a frame rate when displaying continuous time-based content refers to the accompanying drawings. The detailed description is not intended to limit the methods and apparatuses for adjusting a frame rate when displaying continuous time-based content. Instead, the scope of the methods and apparatuses for adjusting a frame rate when displaying continuous time-based content are defined by the appended claims and equivalents. Those skilled in the art will recognize that many other implementations are possible, consistent with the present invention.

References to a “device” include a device utilized by a user such as a computer, a portable computer, a personal digital assistant, a cellular telephone, a gaming console, and a device capable of processing content.

References to “content” include graphical representations both static and dynamic scenes, audio representations, and the like.

References to “scene” include a content that is configured to be presented in a particular manner.

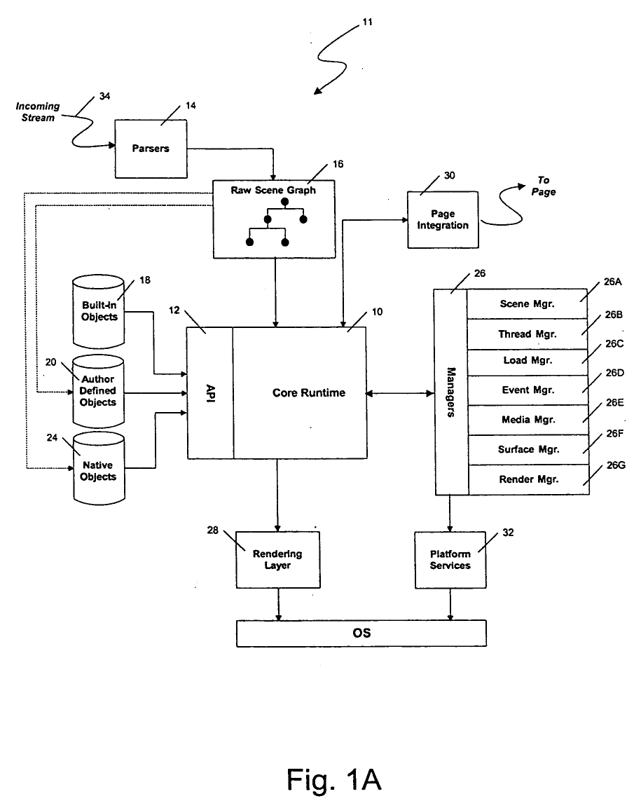

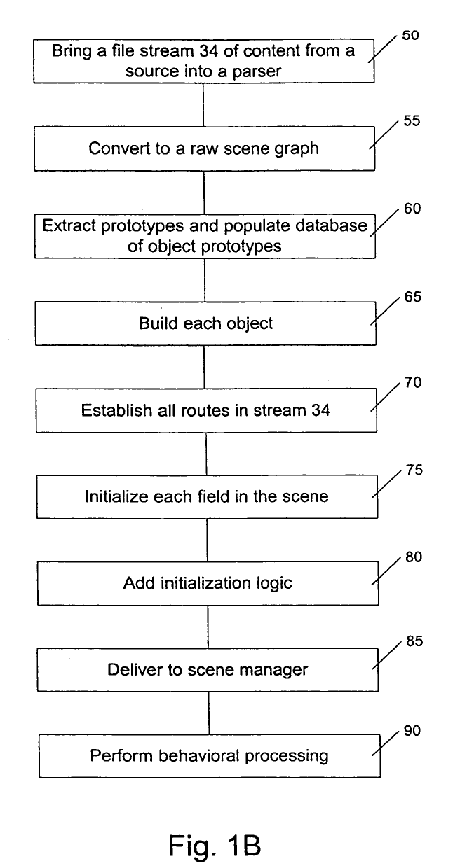

Blendo is an exemplary embodiment of the present invention that allows temporal manipulation of media assets including control of animation and visible imagery, and cueing of audio media, video media, animation and event data to a media asset that is being played. FIG. 1A shows basic Blendo architecture. At the core of the Blendo architecture is a Core Runtime module 10 (Core hereafter) which presents various Application Programmer Interface (API hereafter) elements and the object model to a set of objects present in system 11. During normal operation, a file is parsed by parser 14 into a raw scene graph 16 and passed on to Core 10, where its objects are instantiated and a runtime scene graph is built. The objects can be built-in objects 18, author defined objects 20, native objects 24, or the like. The objects use a set of available managers 26 to obtain platform services 32. These platform services 32 include event handling, loading of assets, playing of media, and the like. The objects use rendering layer 28 to compose intermediate or final images for display. A page integration component 30 is used to interface Blendo to an external environment, such as an HTML or XML page.

Blendo contains a system object with references to the set of managers 26. Each manager 26 provides the set of APIs to control some aspect of system 11. An event manager 26D provides access to incoming system events originated by user input or environmental events. A load manager 26C facilitates the loading of Blendo files and native node implementations. A media manager 26E provides the ability to load, control and play audio, image and video media assets. A render manager 26G allows the creation and management of objects used to render scenes. A scene manager 26A controls the scene graph. A surface manager 26F allows the creation and management of surfaces onto which scene elements and other assets may be composited. A thread manager 26B gives authors the ability to spawn and control threads and to communicate between them.

FIG. 1B illustrates in a flow diagram, a conceptual description of the flow of content through a Blendo engine. In block 50, a presentation begins with a source which includes a file or stream 34 (FIG. 1A) of content being brought into parser 14 (FIG. 1A). The source could be in a native VRML-like textual format, a native binary format, an XML based format, or the like. Regardless of the format of the source, in block 55, the source is converted into raw scene graph 16 (FIG. 1A). The raw scene graph 16 can represent the nodes, fields and other objects in the content, as well as field initialization values. It also can contain a description of object prototypes, external prototype references in the stream 34, and route statements.

The top level of raw scene graph 16 include nodes, top level fields and functions, prototypes and routes contained in the file. Blendo allows fields and functions at the top level in addition to traditional elements. These are used to provide an interface to an external environment, such as an HTML page. They also provide the object interface when a stream 34 is used as the contents of an external prototype.

Each raw node includes a list of the fields initialized within its context. Each raw field entry includes the name, type (if given) and data value(s) for that field. Each data value includes a number, a string, a raw node, and/or a raw field that can represent an explicitly typed field value.

In block 60, the prototypes are extracted from the top level of raw scene graph 16 (FIG. 1A) and used to populate the database of object prototypes accessible by this scene.

The raw scene graph 16 is then sent through a build traversal. During this traversal, each object is built (block 65), using the database of object prototypes.

In block 70, the routes in stream 34 are established. Subsequently, in block 75, each field in the scene is initialized. This is done by sending initial events to non-default fields of Objects. Since the scene graph structure is achieved through the use of node fields, block 75 also constructs the scene hierarchy as well. Events are fired using in order traversal. The first node encountered enumerates fields in the node. If a field is a node, that node is traversed first.

As a result the nodes in that particular branch of the tree are initialized. Then, an event is sent to that node field with the initial value for the node field. After a given node has had its fields initialized, the author is allowed to add initialization logic (block 80) to prototyped objects to ensure that the node is fully initialized at call time. The blocks described above produce a root scene. In block 85 the scene is delivered to the scene manager 26A (FIG. 1A) created for the scene.

In block 90, the scene manager 26A is used to render and perform behavioral processing either implicitly or under author control. A scene rendered by the scene manager 26A can be constructed using objects from the Blendo object hierarchy. Objects may derive some of their functionality from their parent objects, and subsequently extend or modify their functionality. At the base of the hierarchy is the Object. The two main classes of objects derived from the Object are a Node and a Field. Nodes contain, among other things, a render method, which gets called as part of the render traversal. The data properties of nodes are called fields. Among the Blendo object hierarchy is a class of objects utilized to provide timing of objects, which are described in detail below. The following code portions are for exemplary purposes. It should be noted that the line numbers in each code portion merely represent the line numbers for that particular code portion and do not represent the line numbers in the original source code.

Surface Objects

A Surface Object is a node of type SurfaceNode. A SurfaceNode class is the base class for all objects that describe a 2D image as an array of color, depth and opacity (alpha) values. SurfaceNodes are used primarily to provide an image to be used as a texture map. Derived from the SurfaceNode Class are MovieSurface, ImageSurface, MatteSurface, PixelSurface and SceneSurface. It should be noted the line numbers in each code portion merely represent the line numbers for that code portion and do not represent the line numbers in the original source code.

MovieSurface

The following code portion illustrates the MovieSurface node. A description of each field in the node follows thereafter.

1)MovieSurface: SurfaceNode TimedNode AudioSourceNode {
2) field MF String url [ ]
3) field TimeBaseNode timeBase NULL
4) field Time duration 0
5) field Time loadTime 0
6) field String loadStatus “NONE”
}

A MovieSurface node renders a movie on a surface by providing access to the sequence of images defining the movie. The MovieSurface's TimedNode parent class determines which frame is rendered onto the surface at any one time. Movies can also be used as sources of audio.

In line 2 of the code portion, (“Multiple Value Field) the URL field provides a list of potential locations of the movie data for the surface. The list is ordered such that element 0 describes the preferred source of the data. If for any reason element 0 is unavailable, or in an unsupported format, the next element may be used.

In line 3, the timeBase field, if specified, specifies the node that is to provide the timing information for the movie. In particular, the timeBase will provide the movie with the information needed to determine which frame of the movie to display on the surface at any given instant. If no timeBase is specified, the surface will display the first frame of the movie.

In line 4, the duration field is set by the MovieSurface node to the length of the movie in seconds once the movie data has been fetched.

In line 5 and 6, the loadTime and the loadStatus fields provide information from the MovieSurface node concerning the availability of the movie data. LoadStatus has five possible values, “NONE”, “REQUESTED”, “FAILED”, “ABORTED”, and “LOADED”. “NONE” is the initial state. A “NONE” event is also sent if the node's url is cleared by either setting the number of values to 0 or setting the first URL string to the empty string. When this occurs, the pixels of the surface are set to black and opaque (i.e. color is 0,0,0 and transparency is 0).

A “REQUESTED” event is sent whenever a non-empty url value is set. The pixels of the surface remain unchanged after a “REQUESTED” event.

“FAILED” is sent after a “REQUESTED” event if the movie loading did not succeed. This can happen, for example, if the UIRL refers to a non-existent file or if the file does not contain valid data. The pixels of the surface remain unchanged after a “FAILED” event.

An “ABORTED” event is sent if the current state is “REQUESTED” and then the URL changes again. If the URL is changed to a non-empty value, “ABORTED” is followed by a “REQUESTED” event. If the URL is changed to an empty value, “ABORTED” is followed by a “NONE” value. The pixels of the surface remain unchanged after an “ABORTED” event.

A “LOADED” event is sent when the movie is ready to be displayed. It is followed by a loadtime event whose value matches the current time. The frame of the movie indicated by the timeBase field is rendered onto the surface. If timeBase is NULL, the first frame of the movie is rendered onto the surface.

ImageSurface

The following code portion illustrates the ImageSurface node. A description of each field in the node follows thereafter.

1) ImageSurface: SurfaceNode {
2)field ME String url [ ]
3)field Time loadTime 0
4)field String loadStatus “NONE”
}

An ImageSurface node renders an image file onto a surface. In line 2 of the code portion, the URL field provides a list of potential locations of the image data for the surface. The list is ordered such that element 0 describes the most preferred source of the data. If for any reason element 0 is unavailable, or in an unsupported format, the next element may be used.

In line 3 and 4, the loadtime and the loadStatus fields provide information from the ImageSurface node concerning the availability of the image data. LoadStatus has five possible values, “NONE”, “REQUESTED”, “FAILED”, “ABORTED”, and “LOADED”.

“NONE” is the initial state. A “NONE” event is also sent if the node's URL is cleared by either setting the number of values to 0 or setting the first URL string to the empty string. When this occurs, the pixels of the surface are set to black and opaque (i.e. color is 0,0,0 and transparency is 0).

A “REQUESTED” event is sent whenever a non-empty UIRL value is set. The pixels of the surface remain unchanged after a “REQUESTED” event.

“FAILED” is sent after a “REQUESTED” event if the image loading did not succeed. This can happen, for example, if the UIRL refers to a non-existent file or if the file does not contain valid data. The pixels of the surface remain unchanged after a “FAILED” event.

An “ABORTED” event is sent if the current state is “REQUESTED” and then the URL changes again. If the URL is changed to a non-empty value,

“ABORTED” will be followed by a “REQUESTED” event. If the URL is changed to an empty value, “ABORTED” will be followed by a “NONE” value. The pixels of the surface remain unchanged after an “ABORTED” event.

A “LOADED” event is sent when the image has been rendered onto the 15 surface. It is followed by a loadTime event whose value matches the current time.

MatteSurface

The following code portion illustrates the MatteSurface node. A description of each field in the node follows thereafter.

1) MatteSurface: SurfaceNode {
2) field SurfaceNode surface1 NULL
3) field SurfaceNode surface2 NULL
4) field String operation ‘’’’
5) field MF Float parameter 0
6) field Bool overwriteSurface2 FALSE
}

The MatteSurface node uses image compositing operations to combine the image data from surface 1 and surface 2 onto a third surface. The result of the compositing operation is computed at the resolution of surface2. If the size of surface 1 differs from that of surface 2, the image data on surface 1 is zoomed up or down before performing the operation to make the size of surface 1 equal to the size of surface2.

In lines 2 and 3 of the code portion the surface 1 and surface 2 fields specify the two surfaces that provide the input image data for the compositing operation.

In line 4, the operation field specifies the compositing function to perform on the two input surfaces. Possible operations are described below.

“REPLACE_ALPHA” overwrites the alpha channel A of surface2 with data from surface 1. If surface 1 has 1 component (grayscale intensity only), that component is used as the alpha (opacity) values. If surface 1 has 2 or 4 components (grayscale intensity+alpha or RGBA), the alpha channel A is used to provide the alpha values. If surface 1 has 3 components (RGB), the operation is undefined. This operation can be used to provide static or dynamic alpha masks for static or dynamic images. For example, a SceneSurface could render an animated James Bond character against a transparent background. The alpha component of this image could then be used as a mask shape for a video clip.

“MULTIPLY_ALPHA” is similar to REPLACE_ALPHA. except the alpha values from surface 1 are multiplied with the alpha values from surface 2.

“CROSS_FADE” fades between two surfaces using a parameter value to control the percentage of each surface that is visible. This operation can dynamically fade between two static or dynamic images. By animating the parameter value (line 5) from 0 to 1, the image on surface 1 fades into that of surface 2.

“BLEND” combines the image data from surface 1 and surface 2 using the alpha channel from surface 2 to control the blending percentage. This operation allows the alpha channel of surface 2 to control the blending of the two images. By animating the alpha channel of surface 2 by rendering a SceneSurface or playing a MovieSurface, you can produce a complex traveling matte effect. If R1, G1, B1, and A1 represent the red, green, blue, and alpha values of a pixel of surface 1 and R2, 02, B2, and A2 represent the red, green, blue, and alpha values of the corresponding pixel of surface 2, then the resulting values of the red, green, blue, and alpha components of that pixel are:
red=R1*(1−A2)+R2*A2 (1)
green=G1*(1−A2)+G2*A2 (2)
blue=B1*(1−A2)+B2*A2 (3)
alpha=1 (4)

“ADD”, and “SUBTRACT” add or subtract the color channels of surface 1 and surface 2. The alpha of the result equals the alpha of surface 2.

In line 5, the parameter field provides one or more floating point parameters that can alter the effect of the compositing function. The specific interpretation of the parameter values depends upon which operation is specified.

In line 6, the overwriteSurface2 field indicates whether the MatteSurface node should allocate a new surface for storing the result of the compositing operation (overwriteSurface2=FALSE) or whether the data stored on surface 2 should be overwritten by the compositing operation (overwriteSurface2=TRUE).

PixelSurface

The following code portion illustrates the SceneSurface node. A description of the field in the node follows thereafter.

1) PixelSurface: SurfaceNode {
2)field Image image 0 0 0
}

A PixelSurface node renders an array of user-specified pixels onto a surface. In line 2, the image field describes the pixel data that is rendered onto the surface.

SceneSurface

The following code portion illustrates the use of SceneSurface node. A description of each field in the node follows thereafter.

1)SceneSurface: SurfaceNode {
2)field MF ChildNode children [ ]
3)field UInt32 width
4)field UInt32 height 1
}

A SceneSurface node renders the specified children on a surface of the specified size. The SceneSurface automatically re-renders itself to reflect the current state of its children.

In line 2 of the code portion, the children field describes the ChildNodes to be rendered. Conceptually, the children field describes an entire scene graph that is rendered independently of the scene graph that contains the SceneSurface node.

In lines 3 and 4, the width and height fields specify the size of the surface in pixels. For example, if width is 256 and height is 512, the surface contains a 256×512 array of pixel values.

The MovieSurface, ImageSurface, MafteSurface, PixelSurface and SceneSurface nodes are utilized in rendering a scene.

At the top level of the scene description, the output is mapped onto the display, the “top level Surface.” Instead of rendering its results to the display, the 3D rendered scene can generate its output onto a Surface using one of the above mentioned SurfaceNodes, where the output is available to be incorporated into a richer scene composition as desired by the author. The contents of the Surface, generated by rendering the surface's embedded scene description, can include color information, transparency (alpha channel) and depth, as part of the Surface's structured image organization. An image, in this context is defined to include a video image, a still image, an animation or a scene.

A Surface is also defined to support the specialized requirements of various texture-mapping systems internally, behind a common image management interface. As a result, any Surface producer in the system can be consumed as a texture by the 3D rendering process. Examples of such Surface producers include an Image Surface, a MovieSurface, a MatteSurface, a SceneSurface, and an ApplicationSurface.

An ApplicationSurface maintains image data as rendered by its embedded application process, such as a spreadsheet or word processor, a manner analogous to the application window in a traditional windowing system.

The integration of surface model with rendering production and texture consumption allows declarative authoring of decoupled rendering rates. Traditionally, 3D scenes have been rendered monolithically, producing a final frame rate to the viewer that is governed by the worst-case performance due to scene complexity and texture swapping. In a real-time, continuous composition framework, the Surface abstraction provides a mechanism for decoupling rendering rates for different elements on the same screen. For example, it may be acceptable to portray a web browser that renders slowly, at perhaps 1 frame per second, but only as long as the video frame rate produced by another application and displayed alongside the output of the browser can be sustained at a full 30 frames per second.

If the web browsing application draws into its own Surface, then the screen compositor can render unimpeded at full motion video frame rates, consuming the last fully drawn image from the web browser's Surface as part of its fast screen updates.

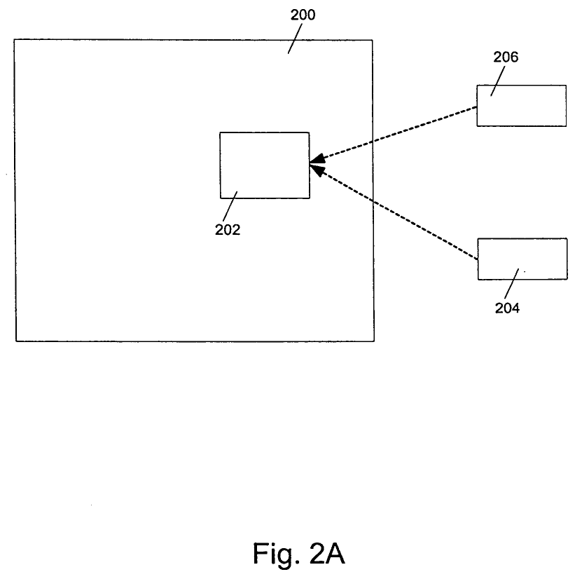

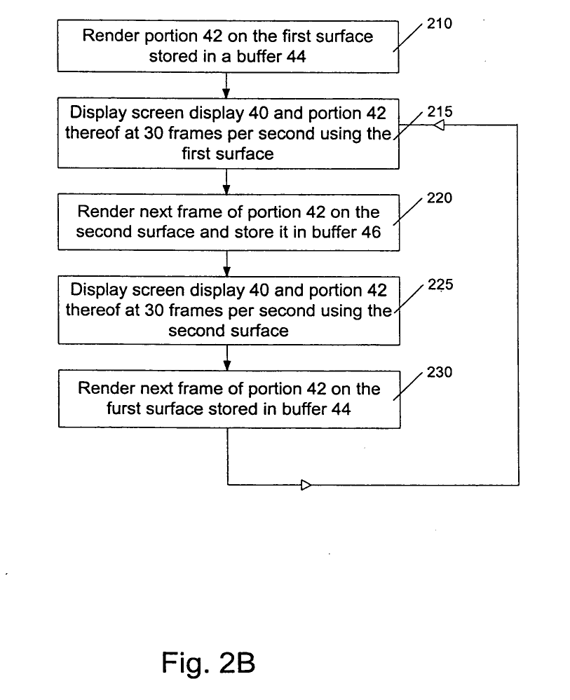

FIG. 2A illustrates a scheme for rendering a complex portion 202 of screen display 200 at full motion video frame rate. FIG. 2B is a flow diagram illustrating various acts included in rendering screen display 200 including complex portion 202 at full motion video rate. It may be desirable for a screen display 200 to be displayed at 30 frames per second, but a portion 202 of screen display 200 may be too complex to display at 30 frames per second. In this case, portion 202 is rendered on a first surface and stored in a buffer 204 as shown in block 210 (FIG. 2B). In block 215, screen display 200 including portion 202 is displayed at 30 frames per second by using the first surface stored in buffer 204. While screen display 200, including portion 200, is being displayed, the next frame of portion 202 is rendered on a second surface and stored in buffer 206 as shown in block 220. Once this next frame of portion 202 is available, the next update of screen display 200 uses the second surface (block 225) and continues to do so until a further updated version of portion 202 is available in buffer 204. While the screen display 200 is being displayed using the second surface, the next frame of portion 202 is being rendered on first surface as shown in block 230. When the rendering of the next frame on the first surface is complete, the updated first surface will be used to display screen display 200 including complex portion 202 at 30 frames per second.

The integration of surface model with rendering production and texture consumption allows nested scenes to be rendered declaratively. Recomposition of subscenes rendered as images enables open-ended authoring. In particular, the use of animated sub-scenes, which are then image-blended into a larger video context, enables a more relevant aesthetic for entertainment computer graphics. For example, the image blending approach provides visual artists with alternatives to the crude hard-edges edged clipping of previous generations of windowing systems.

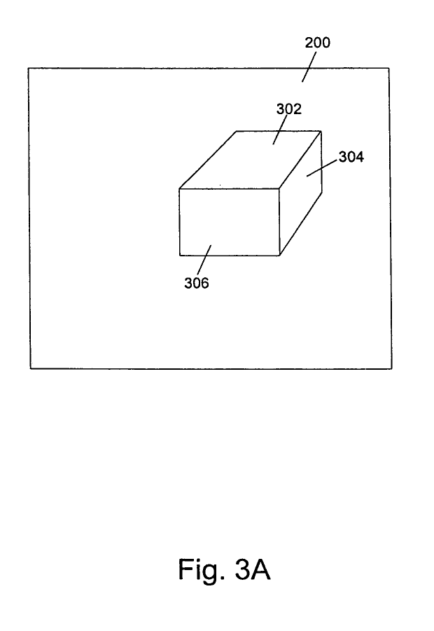

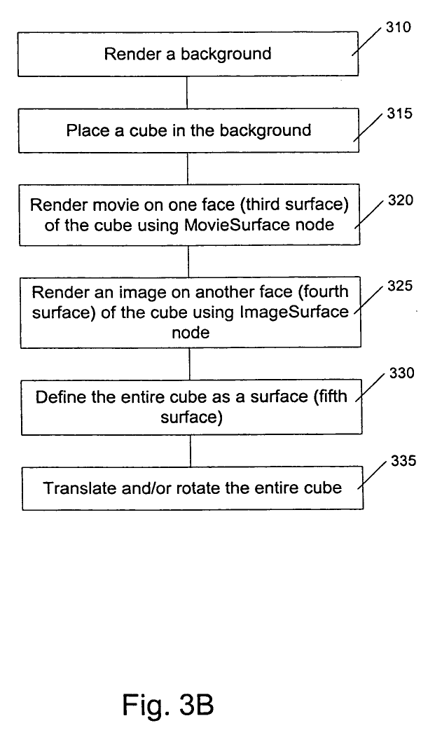

FIG. 3A depicts a nested scene including an animated sub-scene. FIG. 3B is a flow diagram showing acts performed to render the nested scene of FIG. 3A. Block 310 renders a background image displayed on screen display 200, and block 315 places a cube 302 within the background image displayed on screen display 200. The area outside of cube 302 is part of a surface that forms the background for cube 302 on display 200. A face 304 of cube 302 is defined as a third surface. Block 320 renders a movie on the third surface using a MovieSurface node. Thus, face 304 of the cube displays a movie that is rendered on the third surface. Face 306 of cube 302 is defined as a fourth surface. Block 325 renders an image on the fourth surface using an ImageSurface node. Thus, face 306 of the cube displays an image that is rendered on the fourth surface. In block 330, the entire cube 302 is defined as a fifth surface and in block 335 this fifth surface is translated and/or rotated thereby creating a moving cube 302 with a movie playing on face 304 and a static image displayed on face 306. A different rendering can be displayed on each face of cube 302 by following the procedure described above. It should be noted that blocks 310 to 335 can be done in any sequence including starting all the blocks 310 to 335 at the same time.

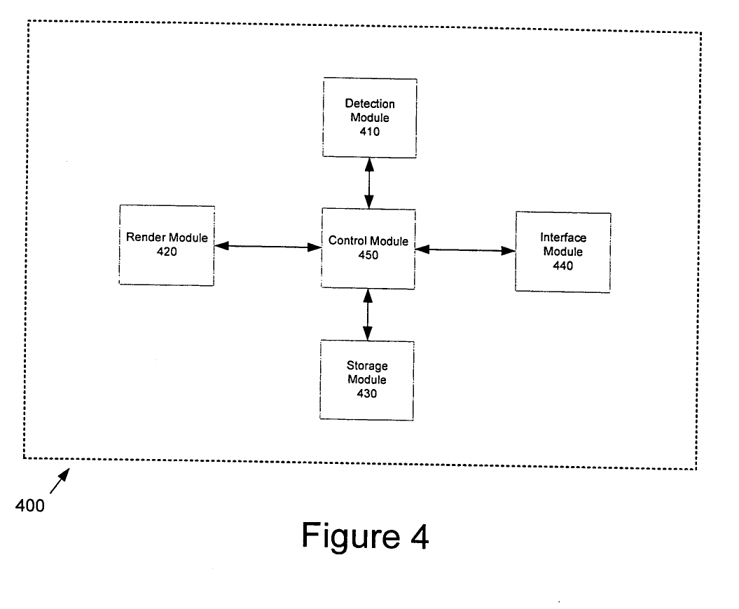

FIG. 4 illustrates one embodiment of a content player system 400. In one embodiment, the system 400 is embodied within the system 110. In another embodiment, the system 400 is embodied as a stand-alone device. In yet another embodiment, the system 400 is coupled with a display device for viewing the content.

In one embodiment, the system 400 includes a detection module 410, a render module 420, a storage module 430, an interface module 440, and a control module 450.

In one embodiment, the control module 450 communicates with the detection module 410, the render module 420, the storage module 430, and the interface module 440. In one embodiment, the control module 450 coordinates tasks, requests, and communications between the detection module 410, the render module 420, the storage module 430, and the interface module 440. In one embodiment, the control module 450 utilizes one of many available central computer processors (CPUs). In one embodiment, the CPU utilizes an operating system such as Windows, Linux, MAC OS, and the like.

In one embodiment, the detection module 410 detects the complexity of the authored content in Blendo. In another embodiment, the detection module 410 also detects the capability of the CPU within the control module 450. In yet another embodiment, the detection module detects the type of operating system utilized by the CPU. In yet another embodiment, the detection module 410 detects other hardware parameters such as graphics hardware, memory speed, hard disk speed, network latency speeds, and the like.

In one embodiment, the render module 420 sets the play back frame rate of the authored content based on the complexity of the content, the type of operating system, and/or the speed of the CPU. In another embodiment, the play back frame rate also depends on the type of display device that is coupled to the system 400. In yet another embodiment, the author of the authored Blendo content is able to specify the play back frame rate.

In one embodiment, the storage module 430 stores the authored content. In one embodiment, the authored content is stored as a declarative language in which the outcome of the scene is described explicitly. Further, the storage module 430 can be utilized as a buffer for the authored content while playing the authored content.

In one embodiment, the interface module 440 receives authored Blendo content that is formatted as a continuous time-based description of an animation. In another embodiment, the interface module 440 transmits a signal that represents an audio/visual portion of the rendered Blendo content for display on a display device.

Referring back to FIG. 1A, in one embodiment, content originates in the form of a Flash file as an swf extension (.swf file) prior to being received by the system 11 (FIG. 1A). In one embodiment, the Flash file is converted into a Blendo recognized format prior to being processed into a raw scene graph 16 (FIG. 1A). In doing so, content that is created by a Flash editor can be utilized by the system 11 as authored Blendo content. In another embodiment, content that is created by any editor can be utilized by the system 11 as authored Blendo content after a conversion is made prior to being processed into a raw scene graph 16.

The system 400 in FIG. 4 is shown for exemplary purposes and is merely one embodiment of the methods and apparatuses for adjusting a frame rate when displaying continuous time-based content. Additional modules may be added to the system 300 without departing from the scope of the methods and apparatuses for adjusting a frame rate when displaying continuous time-based content. Similarly, modules may be combined or deleted without departing from the scope of the methods and apparatuses adjusting a frame rate when displaying continuous time-based content.

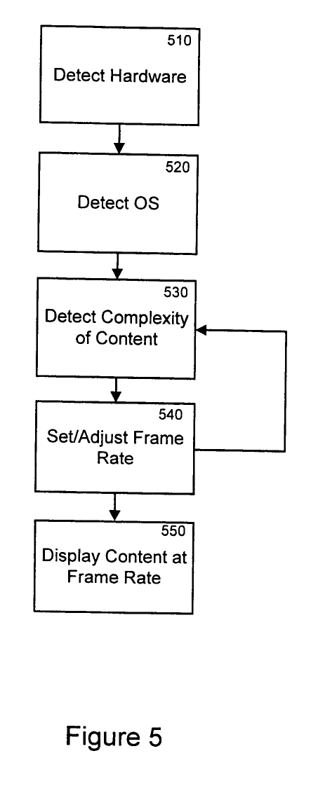

FIG. 5 is a flow diagram that illustrates adjusting the frame rate when playing back content. The blocks within the flow diagram can be performed in a different sequence without departing from the spirit of the methods and apparatuses for adjusting a frame rate when displaying continuous time-based content. Further, blocks can be deleted, added, or combined without departing from the spirit of the methods and apparatuses for adjusting a frame rate when displaying continuous time-based content.

In Block 510, hardware associated with the display device is detected. In one embodiment, the display device is incorporated within the system 11, and the hardware of the system 11 is detected. In another embodiment, the display device is incorporated within the system 400, and the hardware of the system 400 is detected. In one embodiment, the hardware includes a CPU type, a CPU speed, a bus speed, and other factors that effect the performance of the speed of the display device.

In Block 520, the type of operating system is detected within the display device. Linux, Windows, and Mac OS are several exemplary operating systems.

In Block 530, the complexity of the authored Blendo content is detected. In one example, the authored Blendo content is an analog wall clock with only a second hand rotating around the clock face in real time. This single clock with a second hand can be considered a simple animated sequence. In another embodiment, there are ten thousand analog wall clocks wherein each wall clock has a second hand rotating around the clock face in real time. This animated sequence is more complex with ten thousand analog wall clocks.

In Block 540, the frame rate for the authored Blendo content is set based on the hardware detected in the Block 510, the operating system detected in the Block 520, and/or the complexity of the content detected in the Block 530. In one embodiment, the frame rate for the authored Blendo content is optimized based on the speed of the hardware and operating system. With faster hardware and operating systems, the frame rate can be increased. In another embodiment, the frame rate for the authored Blendo content is optimized based on the complexity of the scene being displayed. For example, simpler scenes such as a single analog wall clock can be displayed at higher frame rates. Likewise, more complex scenes such as ten thousand analog wall clock can be displayed at lower frame rates.

In Block 540, the frame rate is continuously adjusted based on the complexity of the scenes. For example, the scene may start out with a very simple single analog wall clock which could be optimized at a higher frame rate. Just moments later, the scene may become much more complex with ten thousand wall clocks and be optimized and adjusted to a lower frame rate.

In Block 550, the authored Blendo content is displayed at the frame rate that is set and adjusted according to the Block 540.

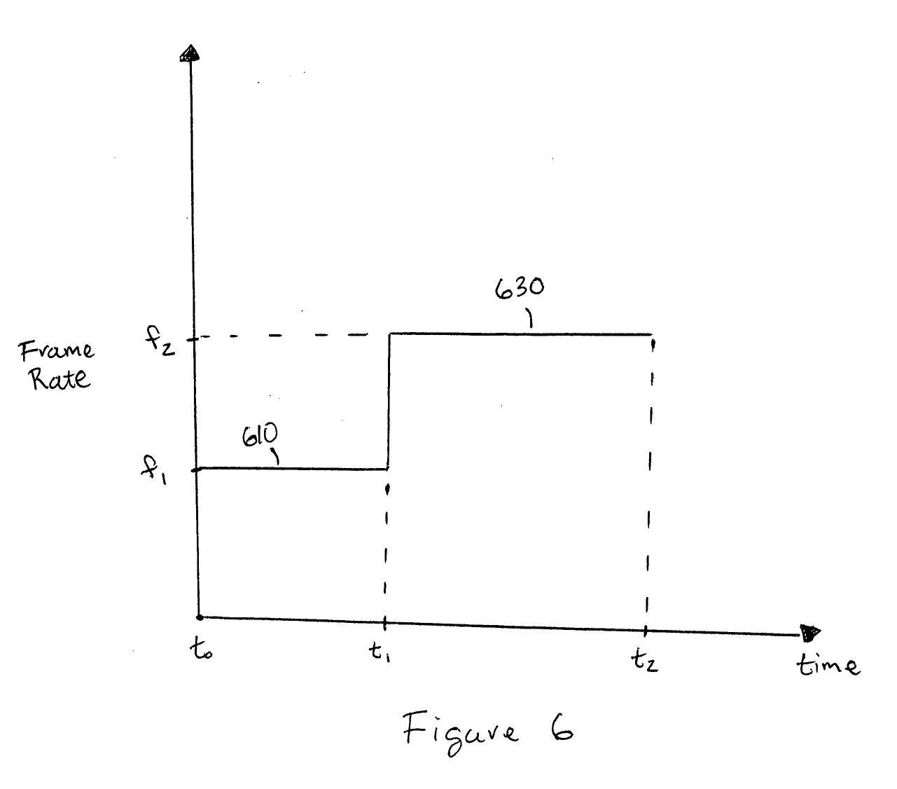

FIG. 6 illustrates a timing diagram that shows varying frame rates for displaying authored Blendo content. The horizontal axis represents time, and the vertical axis represents a frame rate that authored Blendo content is being played at. Segment 610 and segment 630 represents a single piece of authored Blendo content. Further, frame rates f2 and f2 represent different frame rates, and times t0, t1, and t2 represents two different times. In one embodiment, the segment 610 plays from time t0 to time t1 at the frame rate f1, and the segment 630 plays from time t1 to time t2 at the frame rate f2.

The frame rates f1 and f2 can be any frame rate. In one embodiment, frame rate f1 is at 14 frames per second, and frame rate f2 is at 30 frames per second. The times t0, t1, and t2 can be represented by any times. In one embodiment, the time t0 is equal to time at 0 seconds; the time t1 is equal to time at 1 second relative to the time t0; and the time t2 is equal to time at 2 seconds relative to the time t0. In this embodiment, the segment 610 lasts for 1 second and plays at a frame rate of 14 frames per second. Further, the segment 630 lasts for 1 second and plays at a frame rate of 30 frames per second.

In one embodiment, the segment 610 is represented by displaying a thousand analog wall clocks with a second hand rotating around each of the clock faces in real time. In this embodiment, the thousand wall clocks are shown with their second hands displayed at 14 frames per second. For example, the second hands need to keep real time. Within the segment 610 (which lasts for 1 second), the second hands will rotate in a clock-wise direction for the distance of 1 second. Within this one second movement, the second hands are displayed with 14 frames between the initial second (t0) and the terminal second (t1). Further, the movement of the second hands over the 1 second time period is equally split among the 14 frames in one embodiment. For example, the second hand is displayed at 1/14 of a second intervals given the frame rate is 14 frames per second.

In one embodiment, the segment 630 is represented by displaying a single analog wall clock with a second hand rotating around the clock face in real time. In this embodiment, the single wall clock is shown with its second hand displayed at 30 frames per second. For example, the second hand needs to keep real time. Within the segment 610 (which lasts for 1 second), the second hand will rotate in a clock-wise direction for the distance of 1 second. Within this one second movement, the second hand is displayed with 30 frames between the initial second (t1) and the terminal second (t2). Further, the movement of the second hand over the 1 second time period is equally split among the 30 frames in one embodiment. For example, the second hand is displayed at 1/30 of a second intervals given the frame rate is 30 frames per second.

In operation, the system 400 selects the frame rate f1 for the segment 610 based on the hardware, operating system, and complexity of the content as shown in the Blocks 510, 520, and 530 (FIG. 5). Further, as the complexity of the content becomes less complicated with the segment 630 (having only one wall clock instead of a thousand wall clocks), the frame rate f2 is utilized which is higher than the frame rate f1.

In another embodiment, if the frame rate is 20 seconds per frame, then the second hand of the analog clock would be displayed at the 12 o'clock, 4 o'clock, 8 o'clock positions without being displayed in between those points. Further, the second hand would correspond with real time by remaining in each of the 12 o'clock, 4 o'clock, 8 o'clock positions for 20 seconds prior to being moved.

By dynamically adjusting the frame rate for the authored Blendo content prior to the content being played allows the frame rate to be set for the specific parameters of the hardware, operating system, and/or complexity of the content. Further, the frame rate is continually adjusted while playing the content after being initially set based on the complexity of the content. By initially setting the frame rate and continually adjusting the frame rate while the content is playing, the frames that comprise the segments 610 and 630 are shown without unexpectedly and intermittently dropping frames. For example, the visual representation of the segments 610 and 630 are shown through frames that are equally spaced based on the time between each respective frame rate.

In one embodiment, the authored Blendo content does not have a specific frame rate associated with the content prior to being played. The specific frame rate is determined and applied as the content is being played. In another embodiment, the author of the content is able to specify a suggested frame rate for the entire piece of content or specify different frame rates for different segments of the piece of content. However, the frame rate utilized as the content is being played is ultimately determined by the hardware and operating system of the device that displays the content.

The foregoing descriptions of specific embodiments of the invention have been presented for purposes of illustration and description. The invention may be applied to a variety of other applications.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A method comprising:
detecting hardware associated with a device configured for displaying authored content;
setting an initial frame rate for the authored content based on the hardware; and
playing the content at the initial frame rate,
wherein the authored content is scripted in a declarative markup language.

2. The method according to claim 1 further comprising detecting an operating system associated with the device.

3. The method according to claim 2 further comprising setting the initial frame rate for the authored content based on the operating system.

4. The method according to claim 1 further comprising detecting a complexity of the authored content.

5. The method according to claim 4 further comprising setting the initial frame rate for the authored content based on the complexity of the authored content.

6. The method according to claim 4 further comprising adjusting the initial frame rate for the authored content based on the complexity of the authored content.

7. The method according to claim 1 wherein detecting the hardware further comprises detecting a CPU speed.

8. The method according to claim 1 wherein detecting the hardware further comprises detecting a bus speed.

9. The method according to claim 1 wherein detecting the hardware further comprises detecting a hard drive speed.

10. A method comprising:
detecting hardware associated with a device configured for displaying initial authored content;
detecting a complexity the initial authored content; and
setting an initial frame rate playing the initial authored content based on the hardware and the complexity of the initial authored content,
wherein the initial authored content is scripted in a declarative markup language.

11. The method according to claim 10 further comprising adjusting the initial frame rate and forming a subsequent frame rate based on subsequent authored content.

12. The method according to claim 11 wherein the subsequent authored content and the initial authored content are segments of a common piece of content.

13. The method according to claim 11 wherein the subsequent frame rate is higher than the initial frame rate because the subsequent authored content is simpler than the initial authored content.

14. The method according to claim 11 wherein the subsequent frame rate is lower than the initial frame rate because the subsequent authored content is more complex than the initial authored content.

15. The method according to claim 1 wherein the authoring device is a personal computer.

16. A system comprising:
a detection module for detecting performance characteristic associated with a display device configured to play an authored content; and
a render module configured for setting a frame rate based on the performance characteristic associated with the display device,
wherein the authored content is scripted in a declarative markup language.

17. The system according to claim 16 wherein the performance characteristic is based on hardware of the display device.

18. The system according to claim 16 wherein the performance characteristic is based on an operating system of the display device.

19. The system according to claim 16 wherein the performance characteristic is based on a complexity of the authored content.

20. The system according to claim 16 wherein the frame rate is set as an initial frame rate based on an initial authored content.

21. The system according to claim 20 wherein the frame rate is set as a subsequent frame rate based on a subsequent authored content.

22. The system according to claim 21 wherein the initial frame rate is different than the subsequent frame rate.

23. A computer-readable medium having computer executable instructions for performing a method comprising:
detecting hardware associated with a device configured for displaying authored content;
setting an initial frame rate for the authored content based on the hardware; and
playing the content at the initial frame rate, wherein the authored content is scripted in a declarative markup language.

24. A system comprising:
means for detecting hardware associated with a device configured for displaying initial authored content;
means for detecting a complexity the initial authored content; and
means for setting an initial frame rate playing the initial authored content based on the hardware and the complexity of the initial authored content,
wherein the initial authored content is scripted in a declarative markup language.
